(19) United States
(12) Patent Application Publication
(10) Pub. No.: US 2023/0093644 A1
(43) Pub. Date: Mar. 23, 2023

(54) CHISEL

(71) Applicant: JIANGSU WUYUANSU MACHINERY MANUFACTURING CO., LTD, Suzhou (CN)

(72) Inventors: Xiang MIAO, Suzhou (CN); Pengcheng QIN, Suzhou (CN)

(21) Appl. No.: 18/072,547

(22) Filed: Nov. 30, 2022

Related U.S. Application Data
(63) Continuation of application No. PCT/CN2020/117968, filed on Sep. 27, 2020.

(30) Foreign Application Priority Data
May 31, 2020 (CN) 2020104811805

(51) Int. Cl. E21C 35/197

(52) U.S. Cl. CPC E21C 35/197; E01C 23/088

(57) ABSTRACT

Disclosed is a chisel in the application. The chisel includes a chisel end, a chisel holding portion, a holding seat, a limit disc, a hole having an annular surface formed around a central axis L of the limit disc, the limit disc being provided with at least one circle of groove in one side thereof, the groove being penetrated by the hole, the limit disc having a support surface and a first end surface, the groove being transitioned from the support surface to the first end surface, the holding seat being provided with a support portion, and the groove being engaged with the support portion. The chisel in the application may maintain the optimal rotary cutting performance and transmit the working pressure more effectively during operation, which may prolong the service life of the chisel.

### CROSS REFERENCE TO RELATED APPLICATION

This patent application is a continuation application of PCT/CN2020/117968, filed on Sep. 27, 2020, which claims the benefit and priority of Chinese Patent Application No. 202010481180.5 filed on May 31, 2020, the disclosure of which is incorporated by reference herein in its entirety as part of the present application.

### TECHNICAL FIELD

The present disclosure relates to a field of machinery equipment for ground maintenance, and particularly to a chisel with a center limit disc.

### BACKGROUND ART

A known chisel with a handle is applied in machinery equipment for ground maintenance, for example, on a milling drum of a road milling machine, a road surface recycling machine or similar machines; the tip of the chisel, as its main working part, is in direct contact with road base materials that need to be removed. Therefore, the structure of a chisel with a handle plays a key function in the cutting effect of the chisel. However, the chisel with a handle in the related art, due to its regular shape and component structure, rotates not smoothly in use, with an insufficient rotation speed, which causes eccentric wear, short service life, low usage of wear-resistant materials, and low work efficiency.

### SUMMARY

In view of the above defects in the related art, the disclosure aims to provide a chisel with a center limit disc that may maintain the optimal rotary cutting performance and transmit the working pressure more effectively during operation to prolong the service life of the chisel.

In order to achieve the above purpose, a chisel is provided in the disclosure. The chisel includes a chisel end, a chisel holding portion, a holding seat, a limit disc, a hole having an annular surface formed around a central axis L of the limit disc, the limiting disc being provided with at least one groove in one side thereof, the groove being penetrated by the hole, the limit disc having a support surface and a first end surface, the groove being transitioned from the support surface to the first end surface, the holding seat being provided with a support portion, and the groove being engaged with the support portion.

Preferably, the chisel, the groove on the limit disc forms an annular groove around the central axis L.

Preferably, the chisel, a guide surface of the groove extends along a central axis L in a way that the support surface inclines towards a first end surface.

Preferably, the chisel, the guide surface is directly or transitionally connected to the support surface and the first end surface.

Preferably, the chisel, the guide surface and the central axis L are circumferentially arranged at an included angle α, and, the included angle α is 1°-89°.

Preferably, the chisel, the support portion has a first receiving surface, and the first end surface is in contact fit with the first receiving surface.

Preferably, the chisel, the support portion has a locking surface and a second receiving surface, the locking surface is in clearance fit with the guide surface; and the second receiving surface is in clearance fit with the support surface.

Preferably, the chisel, there is a distance a between the support surface and the first end surface, a distance b between the second end surface and the first end surface, and a ratio of the distance b to the distance a is greater than 2, and a ratio of the diameter D1 of the hole to the distance a is greater than 6.

Preferably, the chisel, the distance a between the support surface and the first end surface is 0.5 mm to 3 mm.

Preferably, the chisel, the distance b between the second end surface and the first end surface is 3.5 mm to 10 mm.

Compared with the related art, the present disclosure has the following obvious technical effects:

in the disclosure, a chisel with a center limit disc uses a simpler and more easily machined limit disc, and optimizes the mechanical structure, so that the groove of the limit disc completely embraces the support portion of the holding seat, to maximized guarantee the coaxiality between the chisel position and the holding seat position, and the chisel may maintain the optimal rotary cutting performance during operation, and the guide surface, the support surface and the first end surface of the limit disc respectively correspond to the locking surface of the holding seat, the second receiving surface and the first receiving surface, which increases the corresponding stressed area, transmits the working pressure more effectively, and prolongs the service life of the chisel.

The conception, specific mold cavity and technical effects generated of the present disclosure will be further described below with reference to the accompanying drawings, so as to fully understand the purposes, features, and effects of the present disclosure.

### BRIEF DESCRIPTION OF THE DRAWINGS

FIG. 1 is a semi-sectional view of a chisel mounted in a holding seat in the disclosure;

FIG. 2 is a partial sectional view A in FIG. 1;

FIG. 3 is a partial sectional view B in FIG. 1;

FIG. 4 is a full sectional view of a limit disc for a chisel in the disclosure;

FIG. 5 is a partial sectional view of a support portion of the holding seat in FIG. 1;

FIG. 6 is a perspective view of a work deflection of a chisel mounted in a holding seat in the disclosure.

### DETAILED DESCRIPTION OF THE EMBODIMENTS

The implementation of the disclosure is illustrated by specific examples, and other advantages and effects of the disclosure may be easily understood by those skilled in the art based on the contents disclosed in the specification. The disclosure may also be implemented or applied by other different implementations, and the details in the specification may also be based on different viewpoints and applications, and various modifications or changes may be made without departing from the spirit of the present disclosure. It should be noted that, the following embodiments and features in the embodiments may be combined with each other without conflicts.

It should be noted that the illustrations provided in the following embodiments are merely illustrative of the basic conception of the disclosure, and only related components in the disclosure are only shown in illustrations, but not drawn based on the number, shape and dimension of components in actual implementation, and the type, number and proportion of the components in actual implementation may be arbitrarily changed, and the layout type thereof may also be more complex.

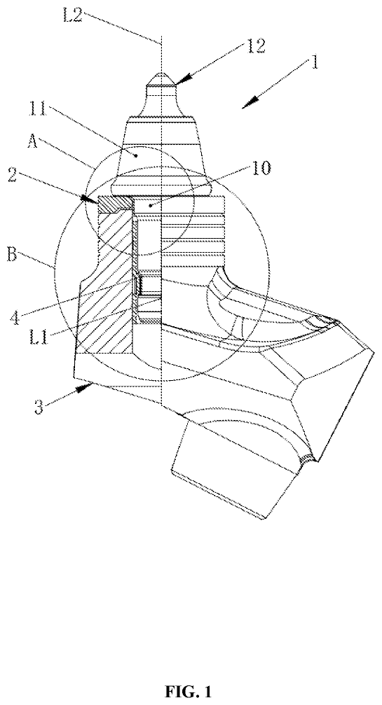

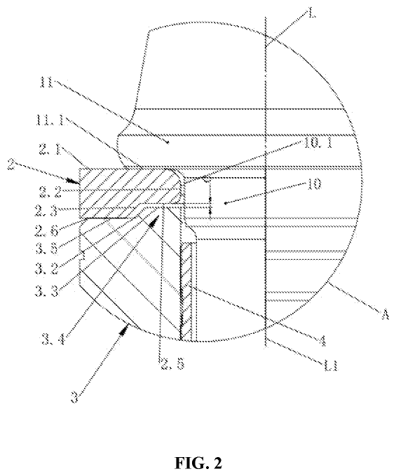

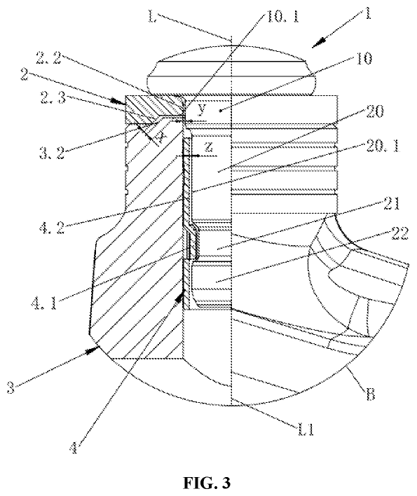

FIGS. 1 to 3 illustrate a front side view of a chisel 1 mounted in a holding seat. Partial views A and B are respectively enlarged in FIG. 2 and FIG. 3, in which a limit disc 2, a holding seat 3 and a fastening sleeve 4 are shown in a semi-sectional view. The chisel 1 includes a head 12 made of tungsten-cobalt-based cemented carbide and permanently fixed in a blind hole-shaped molten pool of a chisel end 11 by brazing. The chisel holding portion 10 extends below a chisel end 11 and is formed by a cylinder with a diameter less than that of the chisel end 11. The limit disc 2 is sleeved on the chisel holding portion 10, the upper end surface of the limit disc 2 is against the plane 11.1 of the chisel end 11, and the lower end surface 2.6 of the limit disc 2 is against the abutting surface 3.5 of the holding seat 3. The steel fastening sleeve 4, is usually rolled by a thin steel sheet, with certain elasticity, is provided with an opening, with an appropriate length, and is sleeved on a holding handle 20, a holding handle 21 and a holding handle 22 of the chisel holding portion 10. A plurality of inner recesses 4.1 are processed on the surface using a stamping process and matched in the holding handle 21, the steel fastening sleeve 4 is pressed into the mounting through hole 14 of the holding seat 3, and the outer side surface is expanded and pressed into the mounting through hole 14 of the holding seat 3 by maintaining fixed contact.

A chisel 1 is provided. The chisel 1 includes a chisel end 11, a chisel holding portion 10, a holding seat 3, a limit disc 2, a hole 13 having an annular surface 2.2 formed around a central axis L of the limit disc 2, the limit disc 2 being provided with at least one circle of groove 2.4 in one side thereof, the groove 2.4 being penetrated by the hole 13, the limit disc 2 having a support surface 2.5 and a first end surface 2.6, the groove 2.4 being transitioned from the support surface 2.5 to the first end surface 2.6, the holding seat 3 being provided with a support portion 3.4, and the groove 2.4 being engaged with the support portion 3.4.

As illustrated in FIG. 2, in the actual working state, the groove 2.4 of the limit disc 2 is configured to be engaged with the support portion 3.4 of the holding seat 3. In terms of relative movement, the holding seat 3 is “fixed”, in this case, the support portion 3.4 of the holding seat 3 is also “fixed”, and the groove 2.4 of the limit disc 2 for the chisel is engaged with the support portion 3.4 of the holding seat 3 to maximize the coaxiality with the position of the holding seat 3.

The groove 2.4 on the limit disc 2 forms an annular groove around the central axis L.

The guide surface 2.3 of the groove 2.4 extends along a central axis L in a way that the support surface 2.5 inclines towards the first end surface 2.6. The guide surface 2.3 is transitionally connected to the first end surface 2.6 by the support surface 2.5 and extended by inclining towards the first end surface 2.6.

The guide surface 2.3 is directly or transitionally connected to the support surface 2.5 and the first end surface 2.6.

The guide surface 2.3 and the central axis L are circumferentially arranged at an included angle α, and, the included angle α is 1°-89°. The included angle α is preferably between 30° and 50°, and especially preferably between 40° and 50°. The limit disc for the chisel is made of steel mold. In the direction of mold discharging, that is, in the direction of the central axis L, a draft angle needs to be made on the groove side, which is beneficial to smoothly pushing out the limit disc from the mold cavity.

The support portion 3.4 has a first receiving surface 3.5, and the first end surface 2.6 is in contact fit with the first receiving surface 3.5.

The support portion 3.4 has a locking surface 3.2 and a second receiving surface 3.3, the locking surface 3.2 is in clearance fit with the guide surface 2.3; and the second receiving surface 3.3 is in clearance fit with the support surface 2.5.

The locking surface 3.2 is in clearance fit with the guide surface 2.3, and there is a certain clearance value x of 0.01 mm to 0.05 mm between the locking surface 3.2 and the guide surface 2.3, so that the groove 2.4 of the limit disc 2 completely embraces the support portion 3.4 of the holding seat 3, and the limit disc 2 and the holding seat 3 may quickly return to the original relative position after separated to a certain extent during operation without jamming when the limit disc 2 is rotated.

The second receiving surface 3.3 is in clearance fit with the support surface 2.5, and the clearance value c and the distance value c being between 0.4 mm and 2.9 mm, which avoids the problem that the first end surface 2.6 cannot contact the first receiving surface 3.5 due to machining errors, and further ensure that the first end surface 2.6 can be in contact fit with the first receiving surface 3.5. When the first end surface 2.6 does not contact the first receiving surface 3.5, the working pressure on the chisel 1 and the limit disc 2 may not be effectively transmitted to the holding seat 3, and the service life of the chisel 1 and the chisel limit disc 2 is greatly affected, and may be quickly damaged under a large impact force.

FIG. 3 illustrates that there is a certain clearance value y between the contour surface 10.1 of the chisel holding part 10 and the hole 13 of the limit disc 2, the value of the clearance y being 0.01 mm to 0.1 mm; there is a certain clearance value z between the contour surface 20.1 of the holding handle 20 and the inner surface 4.2 of the steel fastening sleeve 4, the value of the clearance z being 0.05 mm to 0.2 mm. The purpose of setting and controlling the clearance values x, y, and z is to make full use of the function of the limit disc 2, to ensure that the central axis L2 of the chisel 1 maintains coaxiality with the central axis L1 of the holding seat 3 to the greatest extent during a rotation process, so as to improve the service performance and life of the chisel 1.

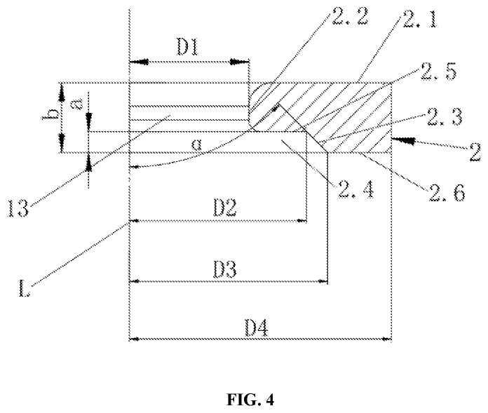

As can be seen from FIG. 4, there is one groove 2.4 on one side of the limit disc 2, the groove 2.4 being penetrated by the hole 13 formed around the central axis L of the limit disc 2 and having a diameter D1, and there is a distance a between the support surface 2.5 and the first end surface 2.6 and a distance b between the second end surface 2.1 and the first end surface 2.6, the ratio of the distance b to the distance a being greater than 2, the ratio of the diameter D1 of the hole 13 to the distance a being greater than 6. The best dimension proportion is selected, which is beneficial to playing the mechanical structure to the best effect. The diameter D1 of the hole 13 ranges from 15 mm to 25 mm; the upper diameter D2 of the groove 2.4 ranges from 30 mm to 35 mm; the lower diameter D3 of the groove 2.4 ranges from 40 mm to 45 mm; the outer diameter D4 of the limit disc 2 ranges from 50 mm to 55 mm.

The distance a between the support surface 2.5 and the first end surface 2.6 is 0.5 mm to 3 mm.

The distance b between the second end surface 2.1 and the first end surface 2.6 is 3.5 mm to 10 mm. Through long-term study on the actual use of the limit disc, the optimal dimension range has been obtained, which may not only effectively ensure the use effect and life of the chisel, but also control the amount of material used, so as not to cause material waste and increase use cost, which maximized combines use effect with material cost to achieve balance and unity of both.

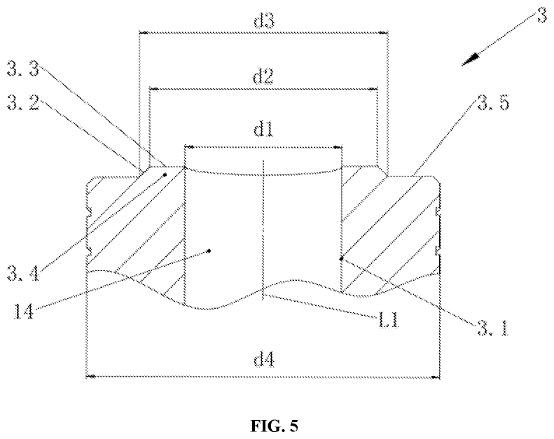

As illustrated in FIG. 5, the support portion 3.4 of the holding seat 3 extends from one side of the abutting surface 3.5 to form a circular boss shape, with the receiving surface 3.3 as a termination surface in the length direction and the transition surface 3.2 as a termination surface in the diameter direction, and from a mounting through hole 14 having a diameter d1 ranging from 15 mm to 25 mm around the central axis L1 of the holding portion 3; the upper diameter of the transition surface 3.2 is d2 ranging from 29 mm to 34 mm; the lower diameter is d3 ranging from 39 mm to 44 mm; the outer diameter d4 of the holding seat 3 ranges from 50 mm to 55 mm. And the value of the distance c between the receiving surface 3.3 of the support portion 3.4 and the first stress surface 3.5 ranges from 0.4 mm to 2.9 mm.

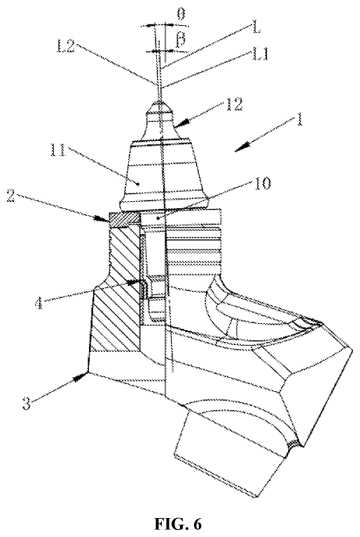

FIG. 6 is a front side view of a chisel 1 mounted in a holding seat 3. The central axis L1 of the holding seat 3 and the central axis L of the limit disc 2 form an included angle β ranging from 0.01° to 0.15°; the central axis L of the limit disc 2 and the central axis L2 of the chisel 1 form an included angle θ ranging from 0.05° to 0.2°. The chisel 1 needs to keep rotating at high speed in the mounting hole 14 of the holding seat 3. For this purpose, the central axis L2 of the chisel 1 needs to maintain coaxiality with the central axis L1 of the holding seat 3 to the greatest extent during a rotation process, which is beneficial to improving the use performance of the chisel 1, therefore, the limit disc 2 plays a vital role in improving the coaxiality of the central axis L2 and the central axis L1, and achieves the beneficial effects of the disclosure.

The above description is only a preferred embodiment of the disclosure and an illustration of the applied technical principles. Those skilled in the art should understand that the scopes involved in the disclosure are not limited to the technical solutions formed by a specific combination of the above technical features, and should also cover other technical solutions formed by any combination of the above technical features or its equivalent features without departing from the above public conception. For example, a technical solution formed by substituting the above features with the technical features (but not limited to) with similar functions disclosed in this application.

The above embodiments merely illustrate the principles and effects of the disclosure, but are not intended to limit the disclosure. Those skilled in the art may modify or change the above embodiments without departing from the spirit and scope of the disclosure. Therefore, all equivalent modifications or changes made by those with ordinary knowledge in the technical field without departing from the spirit and technical idea disclosed in the disclosure should remain be covered by the claims of the disclosure.

What is claimed is:

1. A chisel (1), comprising a chisel end (11), a chisel holding portion (10), a holding seat (3), a limit disc (2), a hole (13) having an annular surface (2.2) formed around a central axis L of the limit disc (2), the limit disc (2) being provided with at least one circle of groove (2.4) in one side thereof, the groove (2.4) being penetrated by the hole (13), the limit disc (2) having a support surface (2.5) and a first end surface (2.6), the groove (2.4) being transitioned from the support surface (2.5) to the first end surface (2.6), the holding seat (3) being provided with a support portion (3.4), and the groove (2.4) being engaged with the support portion (3.4).

2. The chisel (1) of claim 1, wherein, the groove (2.4) on the limit disc (2) forms an annular groove around a central axis L.

3. The chisel (1) of claim 1, wherein, a guide surface (2.3) of the groove (2.4) extends along a central axis L in a way that the support surface (2.5) inclines towards the first end surface (2.6).

4. The chisel (1) of claim 3, wherein, the guide surface (2.3) is directly or transitionally connected to the support surface (2.5) and the first end surface (2.6).

5. The chisel (1) of claim 4, wherein, the guide surface (2.3) and the central axis L are circumferentially arranged at an included angle α, and, the included angle α is 1°-89°.

6. The chisel (1) of claim 1, wherein, the support portion (3.4) has a first receiving surface (3.5), and the first end surface (2.6) is in contact fit with the first receiving surface (3.5).

7. The chisel (1) of claim 1, wherein, the support portion (3.4) has a locking surface (3.2) and a second receiving surface (3.3), the locking surface (3.2) is in clearance fit with the guide surface (2.3); and the second receiving surface (3.3) is in clearance fit with the support surface (2.5).

8. The chisel (1) of claim 1, wherein, there is a distance a between the support surface (2.5) and the first end surface (2.6), a distance b between the second end surface (2.1) and the first end surface (2.6), and a ratio of the distance b to the distance a is greater than 2, and a ratio of the diameter D1 of the hole (13) to the distance a is greater than 6.

9. The chisel (1) of claim 8, wherein, the distance a between the support surface (2.5) and the first end surface (2.6) is 0.5 mm to 3 mm.

10. The chisel (1) of claim 8, wherein, the distance b between the second end surface (2.1) and the first end surface (2.6) is 3.5 mm to 10 mm.
